(19) United States
(12) Patent Application Publication
(10) Pub. No.: US 2008/0252027 A1
(43) Pub. Date: Oct. 16, 2008

(54) Golf Trolley with Easy-Collapsed Auxiliary Wheel

(76) Inventor: Wen-Tsan Lin, Taichung (TW)

Correspondence Address: HDSL, 4331 STEVENS BATTLE LANE, FAIRFAX, VA, 22033, US

(21) Appl. No.: 11/733,755

(22) Filed: Apr. 10, 2007

(51) Int. Cl. B62B 3/02

(52) U.S. Cl. 280/47.34

(57) ABSTRACT

A golf trolley with an easy-collapsed auxiliary wheel includes a golf trolley frame, an auxiliary wheel frame and two joint of rotary shafts. The joints of rotary shafts pivot between the golf trolley frame with a first rotary shaft member and the auxiliary wheel frame with a second one, and the first and the second rotary shaft member are controlled by a shaft lever of an eccentric pressure plate for locking or unlocking. Accordingly, the auxiliary wheel frame rotating unrestricted when releasing the eccentric pressure plate and then the first and the second rotary shaft member, whereas it is locked when pulling the said eccentric pressure plate and then locking the first and the second rotary shaft member.

### FIELD OF THE INVENTION

The present invention relates to a collapsing and spreading technique of a golf trolley, and more particularly relates to a golf trolley with easy-collapsed auxiliary wheel to improve the convenience in operating.

### BACKGROUND OF THE INVENTION

The golf sport attracts people recently resulting from its compound functions in exercise and leisure pleasure since a golf course is usually located at the suburb with broad field and beautiful scenery for people to enjoy. For the sake of meeting various playing conditions, people commonly place many different-typed golf clubs in their caddie bag under the consideration of portability and protection. Moreover, placing the caddie bag on a golf trolley lighten the load and improve the mobility.

However, mostly the traditional golf trolleys are two-wheeled design so that they cannot adapt to the landform of the golf course flexibly during moving and parking. Accordingly, some of them are assembled an auxiliary wheel in the front end to improve the balance. Unfortunately, the height increasing from assembling the auxiliary wheel induces the moving inconvenience and the storing space expense, and a more effective and convenient way is to collapse the auxiliary wheel and eliminate the restriction on performing the process in both hands.

In response to the mentioned problem, the present invention provides a golf trolley with an easy-collapsed auxiliary wheel to overcome the drawbacks of the prior art.

### BRIEF SUMMARY OF THE INVENTION

The present invention provides a golf trolley with an easy-collapsed auxiliary wheel, and users of the invented golf trolley can easily collapse and spread the auxiliary wheel in one hand.

Accordingly, the present invention includes a golf trolley frame, an auxiliary wheel frame and two joint of rotary shafts. The golf trolley frame with an upper and a lower end having a first strut and a second strut, which both sides of it pivot a first and a second wheel rotatable at the original position. The auxiliary wheel frame with a first and a second arm pivot an auxiliary wheel and a horizontal lever for the auxiliary wheel frame pivoting and rotatable under the lower end of the first and the second strut. Two joint of rotary shafts pivot between the golf trolley frame and the horizontal lever of the auxiliary wheel frame respectively. Each of the joint of rotary shafts has a first rotary shaft member with one shaft hole and a second one which has another shaft hole with an opposite direction to each other and rotate in response to the first rotary shaft member. The first rotary shaft member is fixed on the lower end of the first and the second strut, and the second rotary shaft member is fixed on both sides of the horizontal lever. A shaft lever is set between the two joint of rotary shafts with a restricting end in one end and an eccentric pressure plate in another end, and at least one pair of a first and a second lock unit in response to the first lock unit is set between the two rotary shaft members. A position of the first lock unit is in response to a spreading position of the auxiliary wheel frame. The auxiliary wheel frame rotates unrestricted when releasing the eccentric pressure plate to release the first and the second lock unit. In addition, the auxiliary wheel frame is fixed when operating the shaft lever of the eccentric pressure plate for pressing and locking the first lock unit of the first rotary shaft member along the direction of the second one of the second rotary shaft member. Thus, the users of the invented golf trolley can collapse and spread the auxiliary wheel rapidly, and the added value, competitive advantages and economic effects of the present invention may be achieved.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 shows a schematic diagram of the invented golf trolley.

FIG. 2 shows a schematic diagram of a decomposition of parts of the invented golf trolley.

FIG. 3 shows a vertical and sectional view of the invented joint of rotary shaft in a fastened status.

FIG. 4 shows a vertical and sectional view of the invented joint of rotary shaft in a released status.

FIG. 5 shows a schematic diagram of a spreading process of the invented auxiliary wheel.

FIG. 6 shows a horizontal and sectional view of a collapsing process of the invented joint of rotary shaft of the auxiliary wheel.

FIG. 7 shows a schematic diagram of the invented golf trolley in a collapsed status.

### DETAILED DESCRIPTION OF THE INVENTION

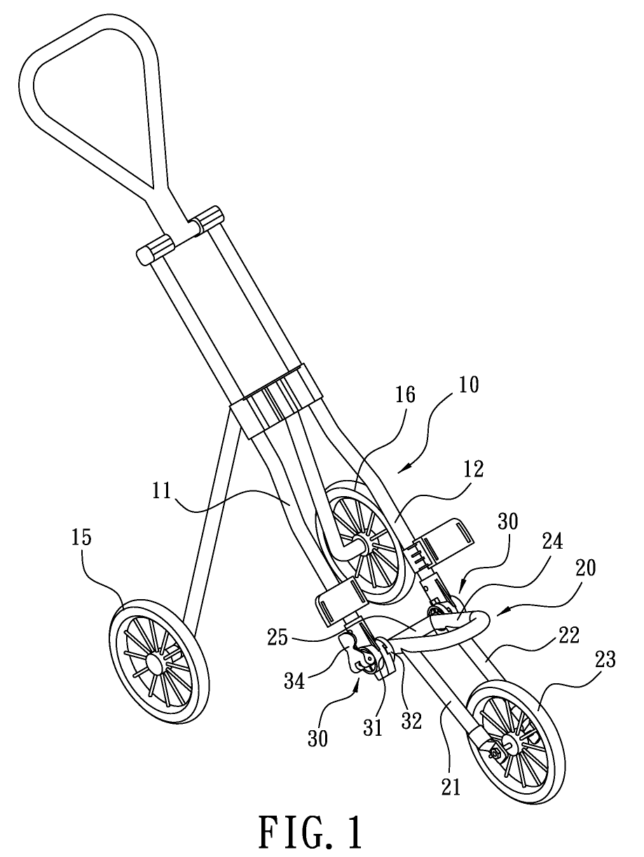

With referring to the FIG. 1, the invented easy-collapsed golf trolley includes a golf trolley frame 10, an auxiliary wheel frame 20 and two joint of rotary shafts 30. The joints of rotary shafts 30 are set between the golf trolley frame 10 and the auxiliary wheel frame 20 so that the auxiliary wheel frame 20 rotates in response to the golf trolley frame 10.

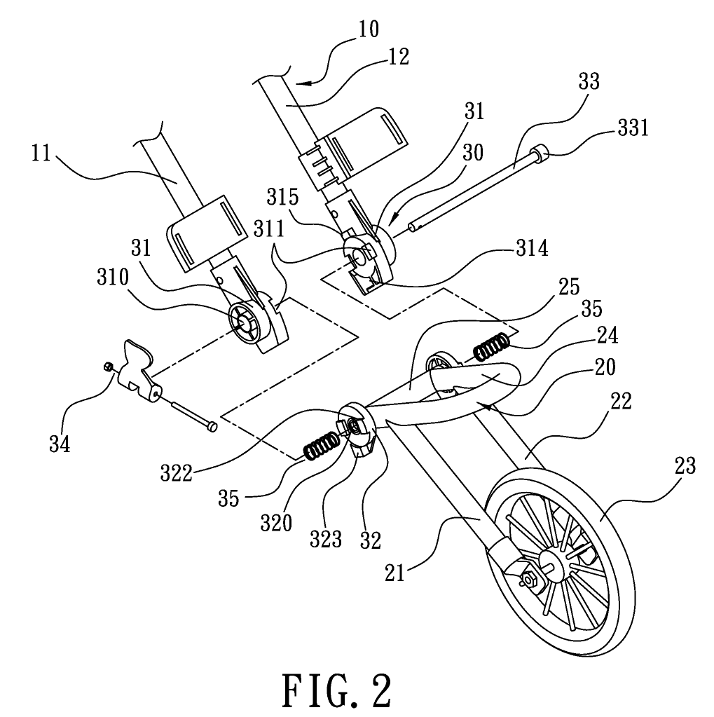

Again, with referring to the FIG. 1 and FIG. 2, the golf trolley frame 10 with an upper end and a lower end having a first strut 11 and a second strut 12 is capable of conveying the caddie bag. Both sides of the golf trolley frame 10 pivot a first wheel 15 and a second wheel 16 rotatable at the original position so that the users can move or change direction of the golf trolley. Preferably, collapsing the first wheel 15 and the second wheel 16 toward the direction of the auxiliary wheel frame 20.

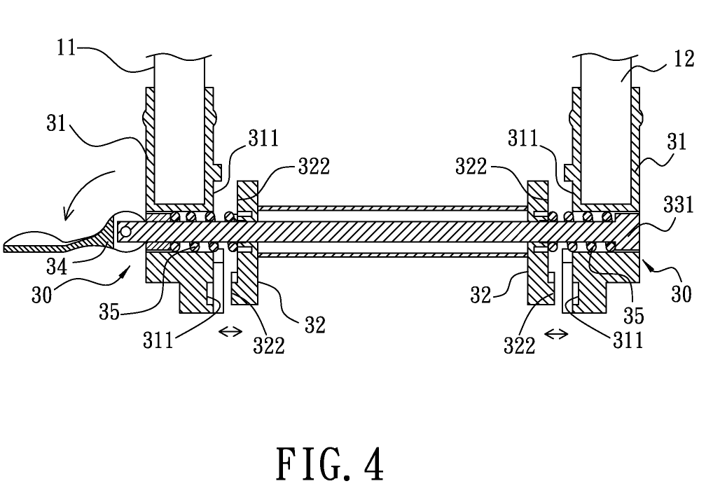

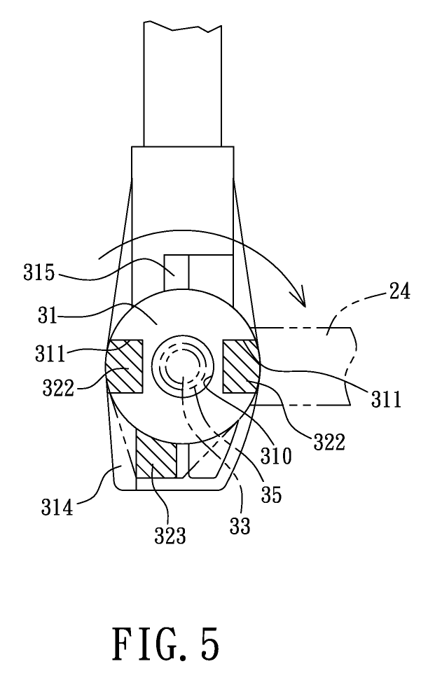

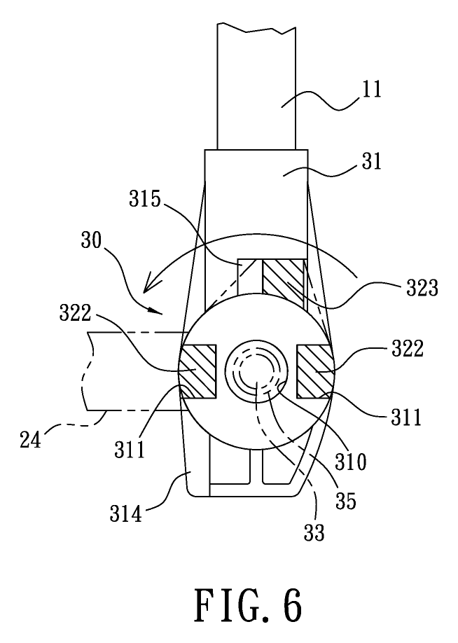

Moreover, the auxiliary wheel frame 20 has a first arm 21 and a second arm 22 in one end pivoting an auxiliary wheel 23 and a frame lever 24 in another end differing from the end pivoting the auxiliary wheel 23 for upward supporting a bottom of the caddie bag and operating the auxiliary wheel frame 20. In addition, the auxiliary wheel frame 20 has a horizontal lever 25 between the first arm 21 and the second arm 22 for the auxiliary wheel frame 20 pivoting rotatably under the lower end of the first strut 11 and the second strut 12. The mentioned two joint of rotary shafts 30 pivot among the first strut 11, the second strut 12 and both ends of the horizontal lever 25 respectively. Each of the joint of rotary shafts 30 has a first rotary shaft member 31 with one shaft hole 310 and a second rotary shaft member 32 with another shaft hole 320. The first rotary shaft member 31 is fixed on the lower end of the first strut 11 and the second strut 12, whereas the second rotary shaft member 32 is fixed on both sides of the horizontal lever 25. The first rotary shaft member 31 and the second rotary shaft member 32 have one or many first lock units 311 and second lock units 322 respectively for locking each other. Herein, for an embodiment of two first lock units 311, the positions of them in response to the positions of spreading and collapsing of the auxiliary wheel frame 20. The periphery of the first rotary shaft member 31 has a second stop unit 314 and a third stop unit 315, and the second rotary shaft member 32 has a corresponding first stop unit 323. The second stop unit 314 and the third stop unit 315 restrict the first stop unit 323 for preventing the joint of rotary shafts 30 exceeding the range of spreading and collapsing as shown in FIGS. 5 and 6. Besides, a shaft lever 33 is set between the two joint of rotary shafts 30 having a restricting end 331 in one end and an eccentric pressure plate 34 pivoting in another end. The shaft lever 33 and the eccentric pressure plate 34 control the status of the first rotary shaft member 31 and the second rotary shaft member 32. Two elastic elements are set between the first rotary shaft member 31 and said second rotary shaft member 32 respectively so that the two rotary shaft members maintain unfolding and then the two lock units maintain unlock when releasing the eccentric pressure plate 34 as shown in FIG. 4.

Accordingly, the first rotary shaft member 31 and the second rotary shaft member 32 are unfolded so that the auxiliary wheel frame 20 can rotate unrestricted while the eccentric pressure plate 34 is released. In contrast, the second lock unit 322 locks the first lock unit 311 to fix the auxiliary wheel frame 20 while operating the shaft lever 33 for pressing the first rotary shaft member 31 along the direction of the second rotary shaft member 32 on the horizontal lever 25.

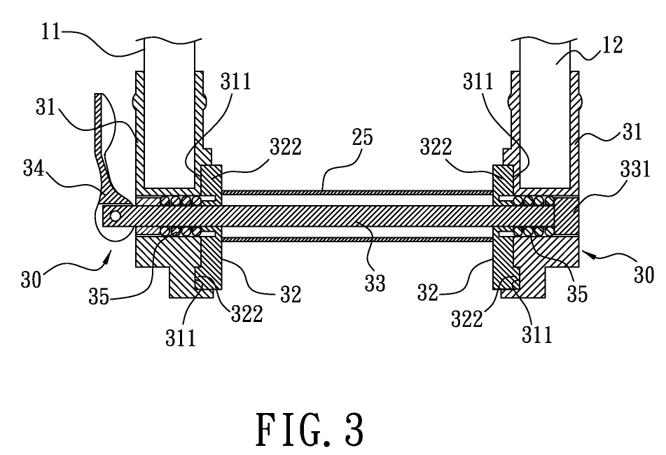

In order to change the golf trolley to the released status, please refer to the FIGS. 1, 3 and 4. Releasing the eccentric pressure plate 34 between the golf trolley frame 10 and the auxiliary wheel frame 20 so that the first rotary shaft member 31 and the second rotary shaft member 32 are unfolded by the elastic elements 35 as shown in FIG. 4. Later, rotating the auxiliary wheel frame 20 to align the second lock unit 322 to the first lock unit 311 and then tightening the eccentric pressure plate 34 to lodge the second lock unit 32 to the first lock unit 311 for spreading and then fixing the auxiliary wheel frame 20 as shown in FIGS. 3 and 5.

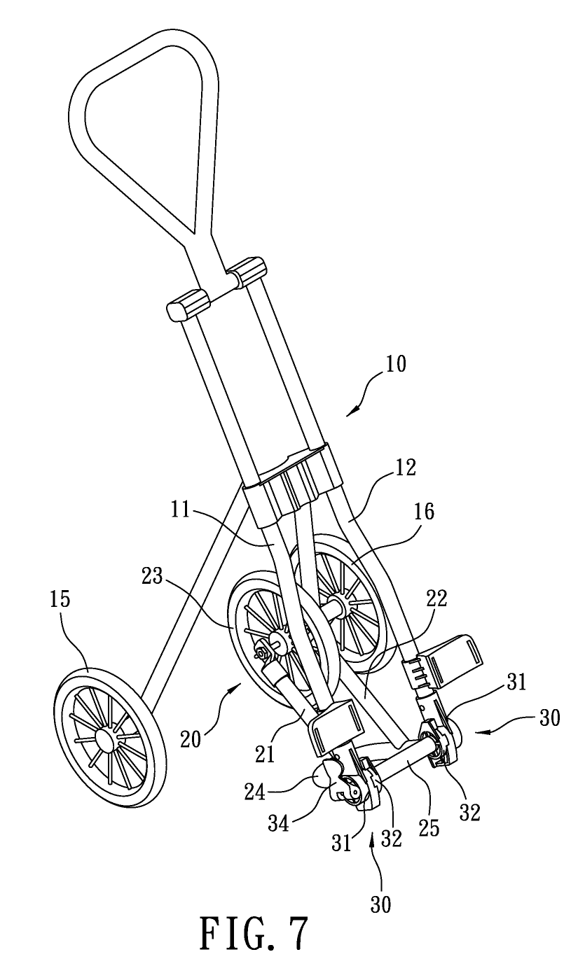

In contrast, the collapsing process of the auxiliary wheel frame 23, as shown in FIGS. 6 and 7, releasing the eccentric pressure plate 34 to control the elastic elements 35 and then to unfold two rotary shaft members as shown in FIG. 4. Later, rotating the auxiliary wheel frame 20 to align the second lock unit 322 to the first lock unit 311, and then tightening the eccentric pressure plate 34 to lodge the second lock unit 322 to the first lock unit 311 to collapse the auxiliary wheel frame 20.

The above description is given by way of example, and not limitation. Given the above disclosure, one skilled in the art could devise variations that are within the scope and spirit of the invention disclosed herein, including configurations ways of the recessed portions and materials and/or designs of the attaching structures. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A golf trolley with an easy-collapsed auxiliary wheel, comprising:
a golf trolley frame with an upper end and a lower end having a first strut and a second strut, which both sides of said golf trolley frame pivot a first wheel and a second wheel rotatable at the original position;
an auxiliary wheel frame with a first arm and a second arm pivot an auxiliary wheel and a horizontal lever for said auxiliary wheel frame pivoting and rotatable under said lower end of said first strut and said second strut; and
two joint of rotary shafts pivot between said golf trolley frame and said horizontal lever respectively, wherein each of said joint of rotary shafts has a first rotary shaft member with one shaft hole and a second rotary shaft member with another shaft hole having an opposite direction to each other and rotating in response to said first rotary shaft member; wherein said first rotary shaft member and said second rotary shaft member are fixed on said lower end of said first strut and said second strut and both sides of said horizontal lever respectively, and a shaft lever is set between said two joint of rotary shafts with a restricting end in one end and an eccentric pressure plate in another end at least one pair of a first lock unit and a second lock unit in response to said first lock unit is set between said first rotary shaft member and said second rotary shaft member, which a position of said first lock unit is in response to a spreading position of said auxiliary wheel frame; and wherein said auxiliary wheel frame rotating unrestricted when releasing said eccentric pressure plate and then said first lock unit and said second lock unit, whereas said auxiliary wheel frame is fixed by locking said first lock unit to said second lock unit when operating said shaft lever of said eccentric pressure plate for pressing said first rotary shaft member along said direction of said second rotary shaft member.

2. The golf trolley as claimed in the claim 1, wherein two elastic elements are set between said first rotary shaft member and said second rotary shaft member respectively so that said first rotary shaft member and said second rotary shaft member maintain unfolding and then said first lock unit and said second lock unit maintain unlock when releasing said eccentric pressure plate.

3. The golf trolley as claimed in the claim 1, wherein said first rotary shaft member has two corresponding said first lock units, and the positions of said two first lock units in response to the positions of collapsing upward and spreading downward of said auxiliary wheel frame respectively for said second lock unit to lock and fix during collapsing and spreading.

4. The golf trolley as claimed in the claim 1, wherein said second rotary shaft member of said joint of rotary shaft has a first stop unit and said first rotary shaft member has a second stop unit and a third stop unit for defining an operating range of collapsing upward and spreading downward.

5. The golf trolley as claimed in the claim 1, wherein a frame lever is set on one end pivoting said auxiliary wheel which differs from another end of said first arm and said second arm for upward supporting a bottom of a caddie bag and operating said auxiliary wheel frame.
